(19) United States
(12) Patent Application Publication
(10) Pub. No.: US 2025/0096395 A1
(43) Pub. Date: Mar. 20, 2025

(54) TRACTION BATTERY PACK PRESSURE RELIEF DEVICE WITH RATCHET MECHANISM

(71) Applicant: Ford Global Technologies, LLC, Dearborn, MI (US)

(72) Inventors: Mohammadreza Eftekhari, Novi, MI (US); Kyle Anzicek, Madison Heights, MI (US); Kanchana Perumalla, Troy, MI (US); Daniel Benjamin Kok, Ann Arbor, MI (US)

(21) Appl. No.: 18/469,042

(22) Filed: Sep. 18, 2023

(51) Int. Cl. H01M 50/333; B60L 50/64; H01M 50/204; H01M 50/249

(52) U.S. Cl. CPC H01M 50/333; B60L 50/64; H01M 50/204; H01M 50/249; H01M 2220/20

(57) ABSTRACT

A traction battery assembly includes an enclosure assembly having an interior area, and a pressure relief device having a valve member movable from a closed position to an unlocked-release position, and movable from the unlocked-release position to a locked-release position. The valve member in the closed position blocks flow through the pressure relief device from the interior area. The valve member in the unlocked-release position permits flow from the interior area. The valve member in the locked-release position permits flow from the interior area. A ratchet mechanism that holds the valve member in the locked-release position.

### TECHNICAL FIELD

This disclosure relates generally to electrified vehicle traction battery packs and, more particularly, to pressure relief devices for traction battery packs.

### BACKGROUND

A high-voltage traction battery pack typically powers an electric machine and other electrical loads of an electrified vehicle. The traction battery pack includes a plurality of battery cells and various other battery internal components that are housed inside an enclosure assembly for supporting the electric propulsion of the vehicle. The enclosure assembly is sealed, but vented to help relieve pressure imbalances and prevent moisture from accumulating within the interior of the battery pack.

### SUMMARY

In some aspects, the techniques described herein relate to a traction battery assembly, including: an enclosure assembly having an interior area; a pressure relief device having a valve member movable from a closed position to an unlocked-release position, and movable from the unlocked-release position to a locked-release position, the valve member in the closed position blocking flow through the pressure relief device from the interior area, the valve member in the unlocked-release position permitting flow from the interior area, the valve member in the locked-release position permitting flow from the interior area; and a ratchet mechanism that holds the valve member in the locked-release position.

In some aspects, the techniques described herein relate to a traction battery assembly, wherein the valve member is free to move back-and-forth between the closed position and the unlocked-release position.

In some aspects, the techniques described herein relate to a traction battery assembly, wherein the valve member in the locked-release position permits more flow from the interior area than the valve member in the unlocked-release position.

In some aspects, the techniques described herein relate to a traction battery assembly, further including a biasing device that biases the pressure relief device to the closed position.

In some aspects, the techniques described herein relate to a traction battery assembly, wherein the biasing device is a coil spring.

In some aspects, the techniques described herein relate to a traction battery assembly, wherein the ratchet mechanism includes at least one tooth.

In some aspects, the techniques described herein relate to a traction battery assembly, wherein the ratchet mechanism is configured to block movement of the valve member from the locked-release position back to the unlocked-release position when the ratchet mechanism holds the valve member in the locked-release position.

In some aspects, the techniques described herein relate to a traction battery assembly, wherein the ratchet mechanism is configured to hold the valve member in a first locked-release position that permits a first amount of flow from the interior area, wherein the ratchet mechanism is further configured to hold the valve member in a second locked-release position that permits a second amount of flow from the interior area, the second amount of flow greater than the first amount of flow.

In some aspects, the techniques described herein relate to a traction battery assembly, wherein the valve member translates along an axis when moving from the closed position to the locked-release position, the ratchet mechanism having a first plurality of teeth circumferentially distributed about the axis that hold the valve member in the first locked-release position, the ratchet mechanism having a second plurality of teeth circumferentially distributed about the axis that hold the valve member in the second locked-release position.

In some aspects, the techniques described herein relate to a traction battery assembly, further including a plurality of fingers of the pressure relief device, the plurality of fingers circumferentially distributed about the valve member, each of the fingers within the plurality of fingers including at least one of the teeth in the first plurality of teeth, and at least one of the teeth in the second plurality of teeth.

In some aspects, the techniques described herein relate to a traction battery assembly, including a plurality of battery arrays housed inside the enclosure assembly.

In some aspects, the techniques described herein relate to a traction battery assembly, wherein the valve member is configured to move from the closed position to the unlocked-release position in response to a pressure within the interior area exceeding a pressure outside the interior area by a first amount, wherein the valve member is configured to move from the unlocked-release position to the locked-release position in response to the pressure within the interior area exceeding the pressure outside the interior area by a second amount that is greater than the first amount.

In some aspects, the techniques described herein relate to a traction battery pack flow control method, including: in response to a pressure within an interior area of an enclosure assembly exceeding a pressure outside the interior area by a first amount, transitioning a valve member of a pressure relief device from a closed position to an unlocked-release position; and in response to the pressure within the interior area of the enclosure assembly exceeding the pressure outside the interior area by a second amount that is greater than the first amount, transitioning the valve member to a locked-release position.

In some aspects, the techniques described herein relate to a traction battery pack flow control method, further including holding the valve member in the locked-release position using a ratchet mechanism.

In some aspects, the techniques described herein relate to a traction battery pack flow control method, further including using at least one tooth to hold the valve member in the locked-release position.

In some aspects, the techniques described herein relate to a traction battery pack flow control method, wherein holding the valve member in the locked-release position blocks movement of the valve member back to the unlocked-release position or the closed position.

In some aspects, the techniques described herein relate to a traction battery pack flow control method, wherein the pressure relief device permits more flow from the interior area when the valve member is in the locked-release position than when the valve member is in the unlocked-release position.

In some aspects, the techniques described herein relate to a traction battery pack flow control method, further including biasing the valve member toward the closed position.

In some aspects, the techniques described herein relate to a traction battery pack flow control method, wherein the locked-release position is a first locked-release position, and further including, in response to the pressure within the interior area of the enclosure assembly exceeding the pressure outside the interior area by a third amount that is greater than the second amount, transitioning the valve member to a second locked-release position.

In some aspects, the techniques described herein relate to a traction battery pack flow control method, wherein the pressure relief device permits more flow from the interior area when the valve member is in the second locked-release position than when the valve member is in the first locked-release position.

The embodiments, examples, and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

### BRIEF DESCRIPTION OF THE DRAWINGS

The various features and advantages of this disclosure will become apparent to those skilled in the art from the following detailed description. The drawings that accompany the detailed description can be briefly described as follows.

FIG. 1 schematically illustrates an electrified vehicle.

FIG. 2 is a perspective view of a battery pack from the electrified vehicle of FIG. 1.

FIG. 3 is a perspective view of another battery pack according to another exemplary embodiment.

FIGS. 4A and 4B illustrate perspective and section views of a pressure relief device from the traction battery pack of FIG. 2 in a closed position.

FIGS. 5A and 5B illustrate perspective and section views of the pressure relief device of FIG. 2 in an unlocked-release position.

FIGS. 6A and 6B illustrate perspective and section views of the pressure relief device of FIG. 2 in a first locked-release position.

FIGS. 7A and 7B illustrate perspective and section views of the pressure relief device of FIG. 2 in a second locked-release position.

### DETAILED DESCRIPTION

This disclosure details exemplary traction battery pack designs for use in electrified vehicles. Exemplary traction battery packs can include an enclosure assembly establishing an interior, and a battery array housed within the interior. To balance the pressure inside and outside the battery pack during normal battery operations. a pressure relief device can be disposed within a wall of the enclosure assembly. These and other features are discussed in greater detail in the following paragraphs of this detailed description.

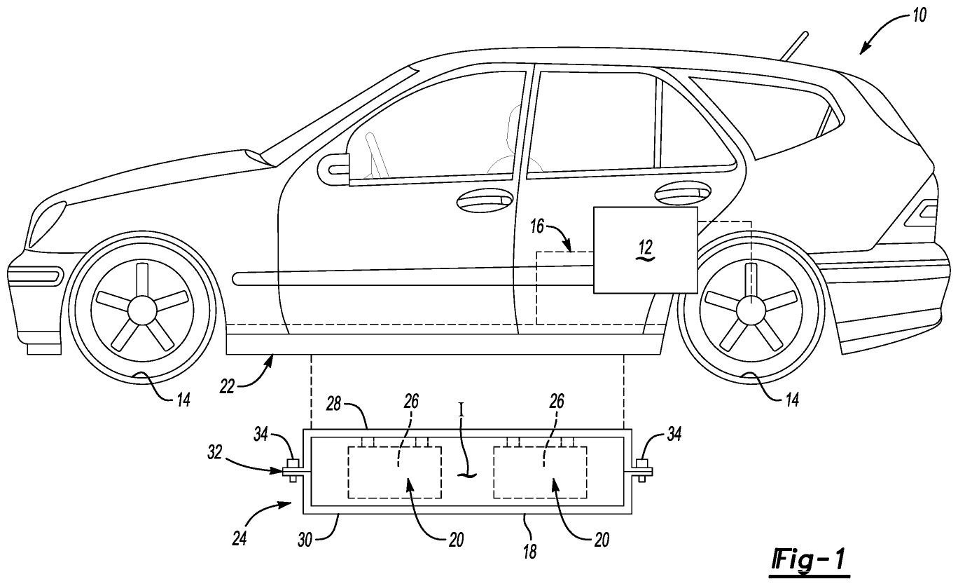

FIG. 1 schematically illustrates an electrified vehicle 10. The electrified vehicle 10 may include any type of electrified powertrain. In an embodiment, the electrified vehicle 10 is a battery electric vehicle (BEV). However, the concepts described herein are not limited to BEVs and could extend to other electrified vehicles, including, but not limited to, hybrid electric vehicles (HEVs), plug-in hybrid electric vehicles (PHEVs), fuel cell vehicles, etc. Therefore, although not specifically shown in the exemplary embodiment, the electrified vehicle 10 could be equipped with an internal combustion engine that can be employed either alone or in combination with other power sources to propel the electrified vehicle 10.

In the illustrated embodiment, the electrified vehicle 10 is a sport utility vehicle (SUV). However, the electrified vehicle 10 could alternatively be a car, a van, a pickup truck, or any other vehicle configuration. Although a specific component relationship is illustrated in the figures of this disclosure, the illustrations are not intended to limit this disclosure. The placement and orientation of the various components of the electrified vehicle 10 are shown schematically and could vary within the scope of this disclosure. In addition, the various figures accompanying this disclosure are not necessarily drawn to scale, and some features may be exaggerated or minimized to emphasize certain details of a particular component or system.

In the illustrated embodiment, the electrified vehicle 10 is a full electric vehicle propelled solely through electric power, such as by one or more electric machines 12, without assistance from an internal combustion engine. The electric machine 12 may operate as an electric motor, an electric generator, or both. The electric machine 12 receives electrical power and can convert the electrical power to torque for driving one or more wheels 14 of the electrified vehicle 10

A voltage bus 16 may electrically couple the electric machine 12 to a traction battery pack 18. The traction battery pack 18 is an exemplary electrified vehicle battery. The traction battery pack 18 may be a high voltage traction battery pack that includes one or more battery arrays 20 (i.e., battery assemblies or groupings of rechargeable battery cells 26) capable of outputting electrical power to power the electric machine 12 and/or other electrical loads of the electrified vehicle 10. Other types of energy storage devices and/or output devices could alternatively or additionally be used to electrically power the electrified vehicle 10.

The battery cells 26 may be stacked side-by-side along a stack axis to construct a grouping of battery cells 26, sometimes referred to as a “cell stack.” In the highly schematic depiction of FIG. 1, the battery cells 26 are stacked in a direction into the page to construct each battery array 20, and thus the battery arrays 20 extend in cross-car direction. However, other configurations may also be possible.

The total number of battery arrays 20 and battery cells 26 provided within the traction battery pack 18 is not intended to limit this disclosure. In an embodiment, the battery cells 26 of each battery array 20 are prismatic, lithium-ion cells. However, battery cells having other geometries (cylindrical, pouch, etc.), other chemistries (nickel-metal hydride, lead-acid, etc.), or both could alternatively be utilized within the scope of this disclosure.

The traction battery pack 18 may be secured to an underbody 22 of the electrified vehicle 10. However, the traction battery pack 18 could be located elsewhere on the electrified vehicle 10 within the scope of this disclosure.

An enclosure assembly 24 houses the battery array 20 of the traction battery pack 18. The enclosure assembly 24 can be a sealed enclosure and, within the scope of this disclosure, may embody any size, shape, and configuration.

In the exemplary embodiment, the enclosure assembly 24 includes an enclosure cover 28 and an enclosure tray 30. Together, the enclosure cover 28 and the enclosure tray 30 may establish an interior I for housing assembly the battery arrays 20 and other battery internal components (e.g., bussed electrical center, battery electric control module, wiring, connectors, etc.) of the traction battery pack 18.

During assembly of the traction battery pack 18, the enclosure cover 28 may be secured to the enclosure tray 30 at an interface 32 therebetween. The interface 32 may substantially circumscribe the interior I. In some implementations, mechanical fasteners 34 may be used to secure the enclosure cover 28 to the enclosure tray 30, although other fastening methodologies (adhesion, etc.) could also be suitable for this purpose.

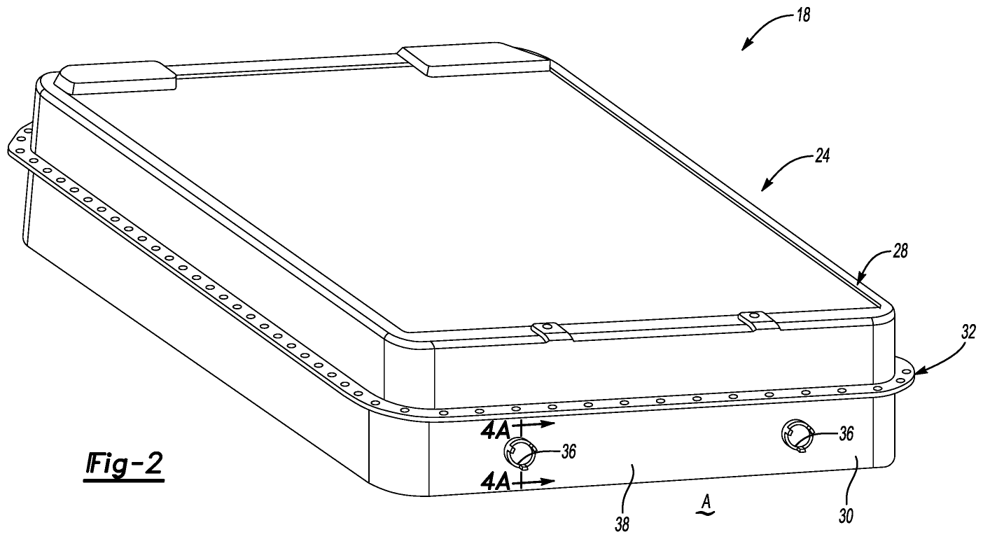

Referring now to FIG. 2, with continued reference to FIG. 1, the traction battery pack 18 may include one or more pressure relief devices 36. Although two pressure relief devices 36 are shown, the traction battery pack 18 may include a greater or fewer number of such devices.

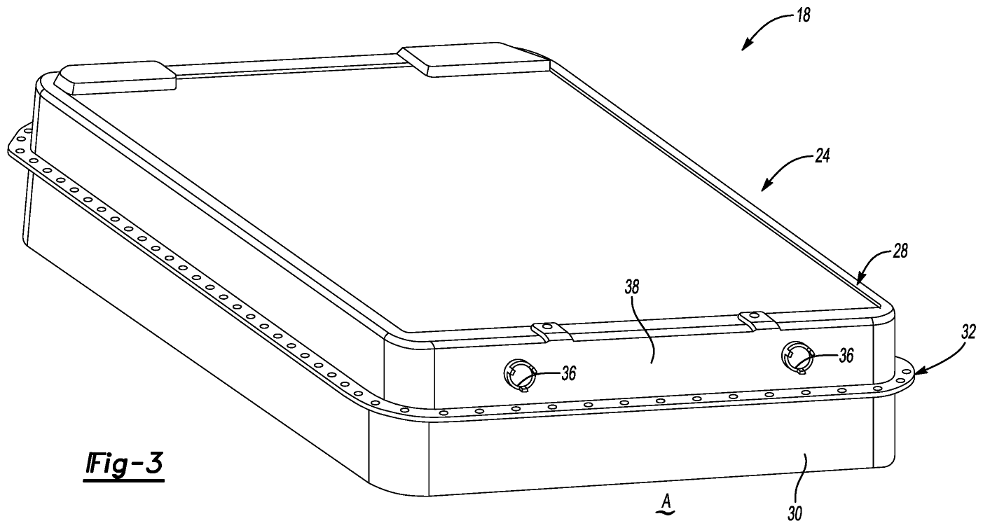

Each pressure relief device 36 can be disposed within a wall 38 of the enclosure assembly 24. In an embodiment, the wall 38 is part of the enclosure tray 30. In another embodiment, the wall 38 is part of the enclosure cover 28 (see FIG. 3). The precise mounting location of each pressure relief device 36 could vary and is therefore not intended to limit this disclosure.

The pressure relief devices 36 can be secured to the wall 38 in any manner. In the example embodiment, each pressure relief device 36 is secured within the wall 38 via a twist-lock style mount. However, the pressure relief devices 36 could alternatively or additionally be mounted via mechanical fasteners, cam locks, adhesion, etc.

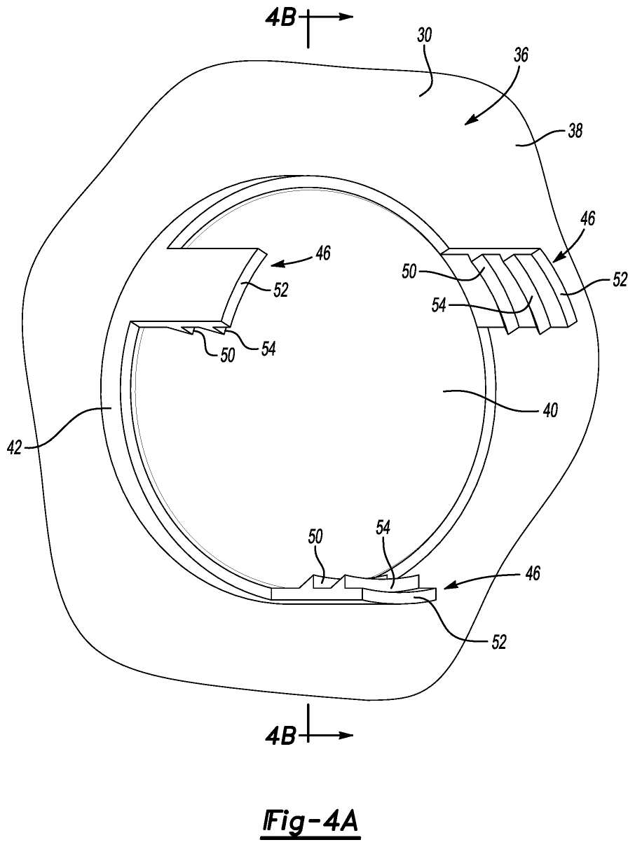

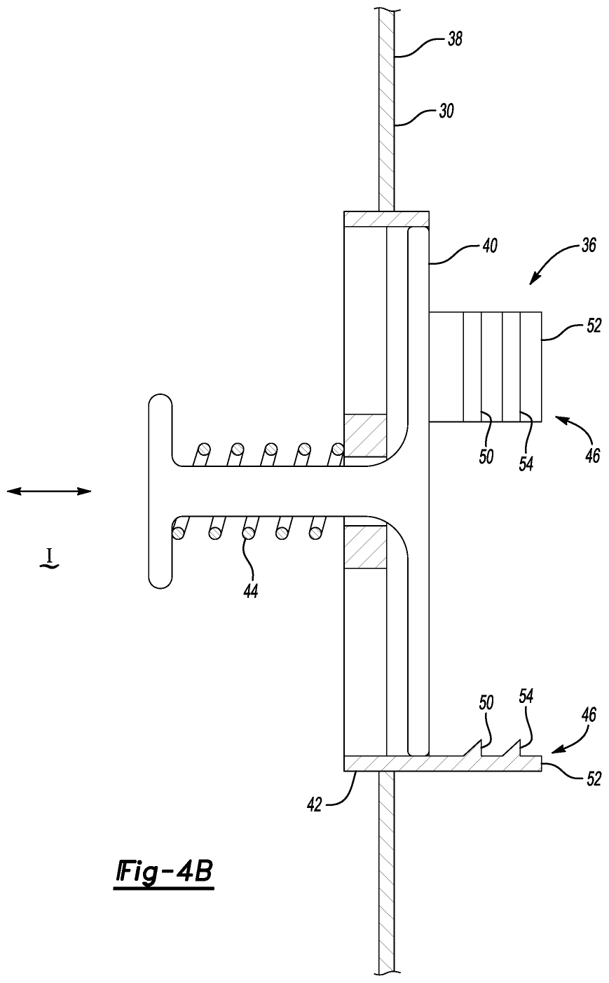

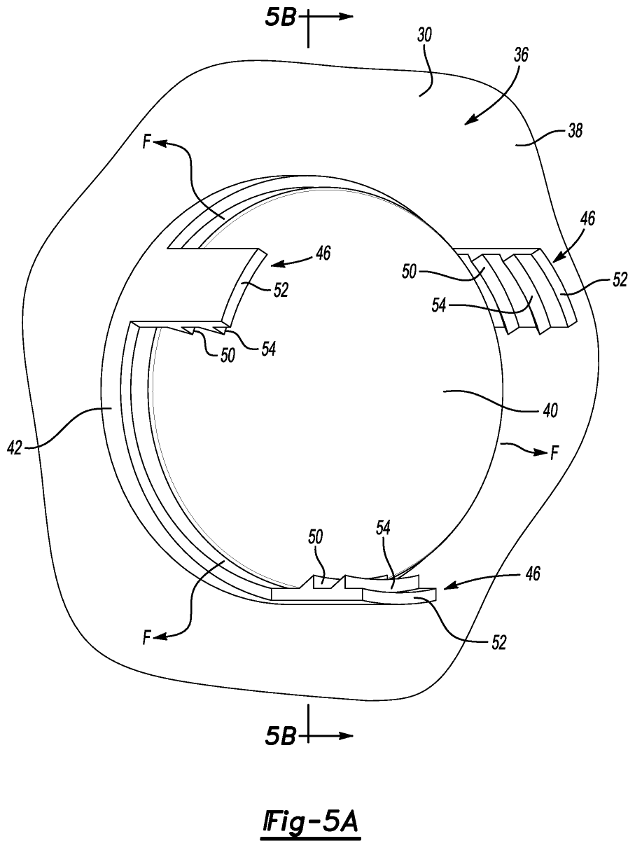

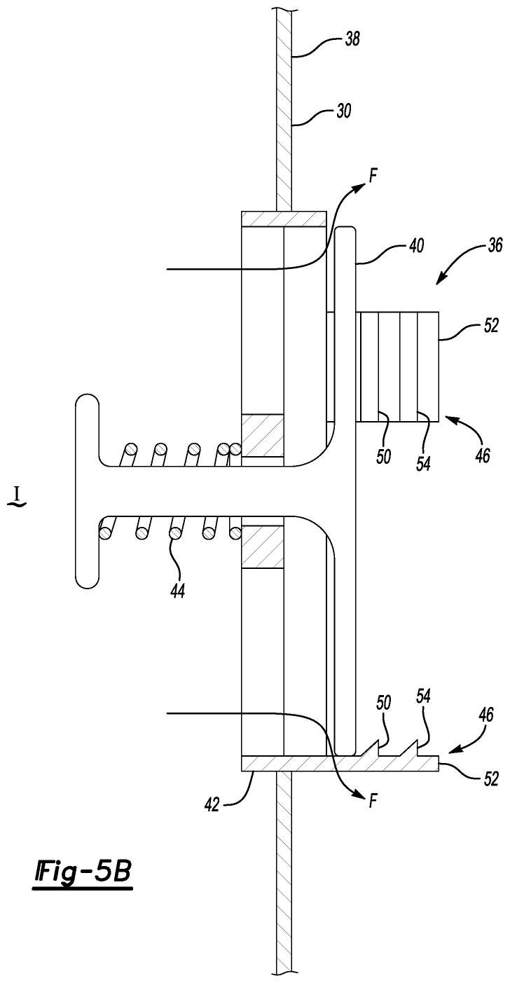

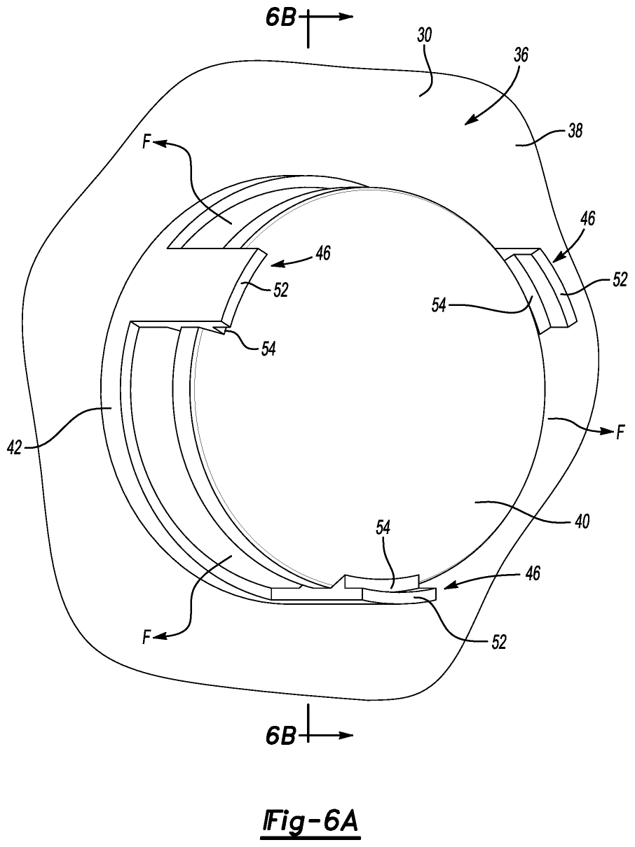

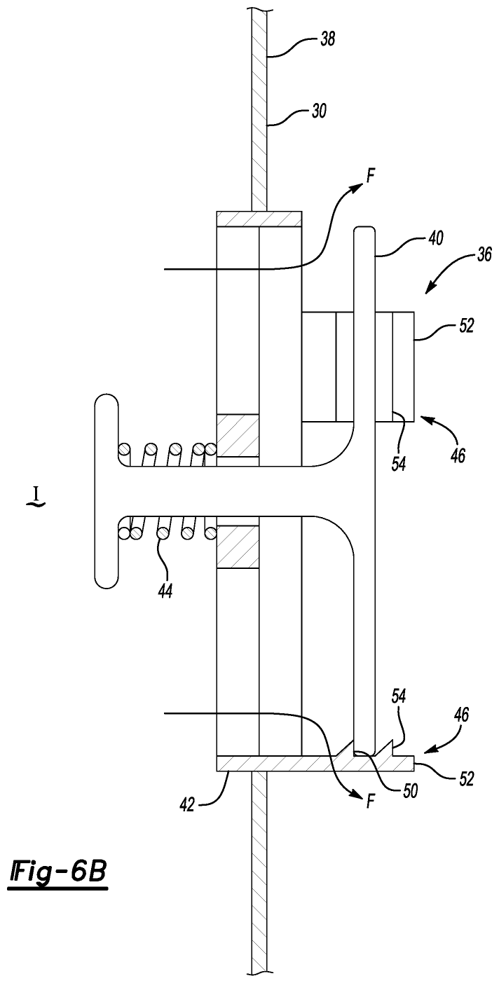

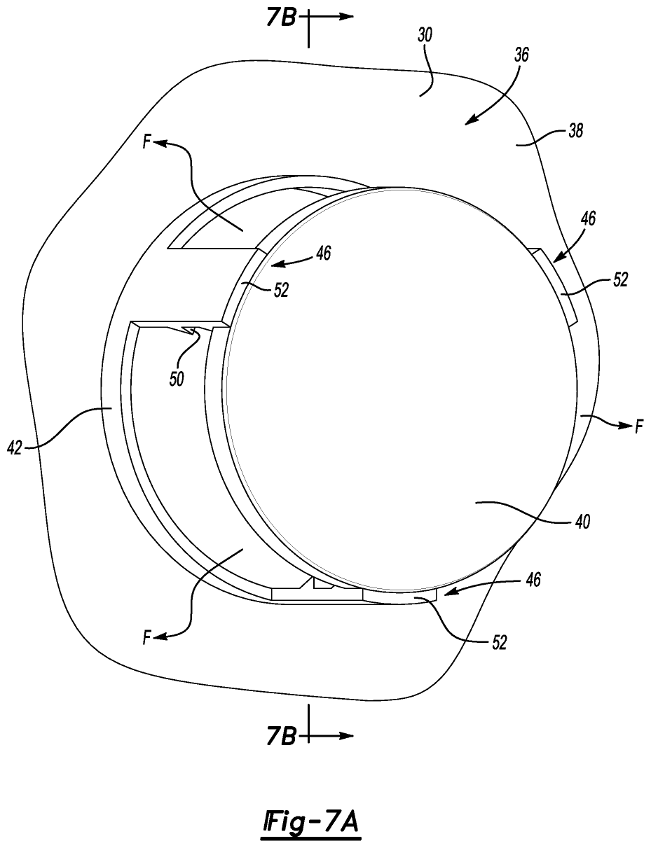

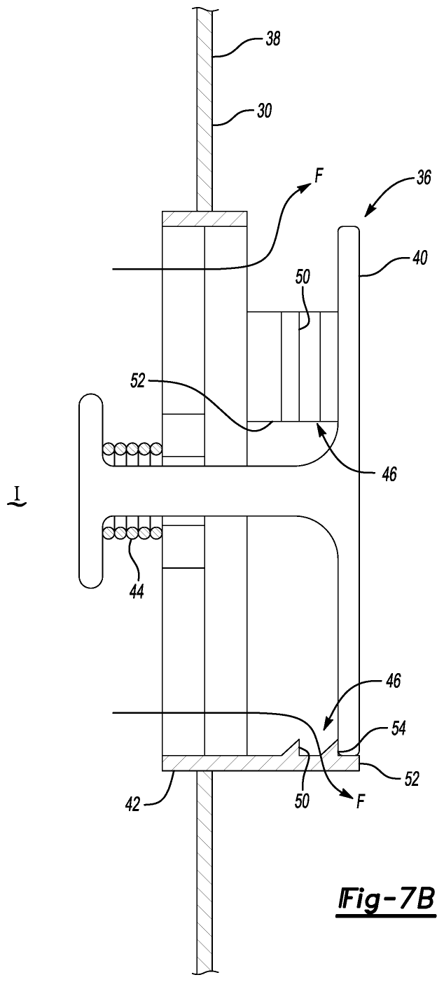

The example pressure relief device includes a valve member 40 movable from a closed position shown in FIGS. 4A and 4B to an unlocked-release position shown in FIGS. 5A and 5B, to a first locked-release position shown in FIGS. 6A and 6B, and to a second locked-release position shown in FIGS. 7A and 7B. The valve member 40 of the pressure relief device 36 can move from the closed position in response to pressure differentials between the interior I of the enclosure assembly 24 and areas outside the enclosure assembly 24.

The valve member 40 in the closed position blocks flow through the pressure relief device 36. The valve member 40 in the unlocked-release position permits a first amount of flow through the pressure relief device 36. The valve member 40 in the first locked-release position permits a second amount of flow through the pressure relief device 36. The second amount of flow is greater than the first amount of flow. The valve member 40 in the second locked-release position permits a third amount of flow through the pressure relief device 36. The third amount of flow is greater than the second amount of flow.

The example pressure relief device 36 includes a housing 42 and a basing member—here a spring 44—in addition to the valve member 40. The housing 42 holds valve member 40 and is secured to the wall 38. The spring 44 biases the valve member 40 to the closed position of FIGS. 4A and 4B. During ordinary operation, the valve member 40 remains in the closed position shown in FIGS. 4A and 4B.

From time to time, pressure within the interior I can increase relative to pressure outside the interior I. The pressure differential between the interior I and an area outside the enclosure assembly 24 can move the valve member 40 from the closed position.

For example, if pressure within the interior I increases to say 0.5 psi more than a pressure outside the interior I, the pressure can overcome the spring bias and move the valve member 40 from the closed position of FIGS. 4A and 4B to the unlocked-release position of FIGS. 5A and 5B. In this position, some flow F can move through the pressure relief device 36 from the interior I to areas outside this interior I. This can help to balance the pressure between the interior I and the areas outside the enclosure assembly 24. After the pressure has substantially equalized, the spring 44 moves the valve member 40 back to the closed position of FIGS. 4A and 4B. The valve member 40 in the unlocked-release position is free to return back to the closed position. If relatively low pressure differences continue, the valve member 40 can continued to move back-and-forth to relieve the pressure differences and balance pressure inside the interior I with pressure outside the interior I.

There may be some operating conditions where pressure and thermal energy within the interior I rapidly increase such that the pressure differences are greater. For example, battery thermal events may occur during over-temperature, over-charging, or over-discharging conditions of battery cells 26, or during other battery cell conditions. Battery vent byproducts may be released from one or more battery cells 26 of the battery arrays 20 during these conditions. This can result in pressure within the interior I rapidly increasing and reaching pressures well above pressures outside the traction battery pack 18. This substantial difference between the pressure within the interior I and the areas outside the interior I can pop the valve member 40 outward from the closed position of FIGS. 4A and 4B, past the unlocked-release position of FIGS. 5A and 5B, and to a locked-release position of FIGS. 6A and 6B. If the pressure differential is even higher, the pressure differential can cause the valve member 40 to project outward past the first locked-release position of FIGS. 6A and 6B to a second locked-release position shown in FIGS. 7A and 7B.

In this example, the housing 42 is equipped with a ratchet mechanism 46 that holds the valve member 40 in the first locked-release position or the second locked-release position. The ratchet mechanism 46 includes, in this example, a first plurality of teeth 50 projecting inward from respective fingers 52 of the housing 42 toward the valve member 40. The fingers 52 are circumferentially distributed about the valve member 40. The ratchet mechanism 46 additionally includes a second plurality of teeth 54 projecting inward from the fingers 52. The second plurality of teeth 54 are spaced further from the interior I than the first plurality of teeth 50.

Other example ratchet mechanisms could the second plurality of teeth 54 and include only the first plurality of teeth 50 such that the valve member 40 is movable to a single locked-release position. Still other ratchet mechanisms could include more than a first and second plurality of teeth and the valve member 40 could be movable to more than two locked-release positions.

As the valve member 40 moves outward from the unlocked-release position of FIGS. 5A and 5B to the first locked-release position of FIGS. 6A and 6B, portions of the valve member 40 slide over the first plurality of teeth 50 forcing the fingers 52 to yield slightly outward away from the valve member 40. After the valve member 40 has moved outward past the first plurality of teeth 50, the fingers 52 snap back inward toward the valve member 40, which places the first plurality of teeth 50 beneath the valve member 40. The valve member 40 rests on the first plurality of teeth 50, which prevents the spring 44 from returning the valve member 40 to the closed position of FIGS. 4A and 4B.

Maintaining the valve member 40 in the first locked release position keeps the pressure relief device 36 open and permits pressure to release from the interior I to an area outside the interior I. Holding the valve in the open position after a thermal event can help to, among other things, prevent the vent byproducts from continuing to build up within the interior I.

If the flow of vent by products and resulting pressure differential were even higher, the valve member 40 can be forced outward from the interior I past the first plurality of teeth 50 and past the second plurality of teeth 54 disposed on the fingers 52. After moving past the second plurality of teeth 54, the valve member 40 can be held by the second plurality of teeth 54. Maintaining the valve member 40 in the second locked-release position permits more flow through the pressure relief device than the valve member 40 when in the first locked-release position of FIGS. 6A and 6B.

Although the different non-limiting embodiments are illustrated as having specific components or steps, the embodiments of this disclosure are not limited to those particular combinations. It is possible to use some of the components or features from any of the non-limiting embodiments in combination with features or components from any of the other non-limiting embodiments.

It should be understood that like reference numerals identify corresponding or similar elements throughout the several drawings. It should be understood that although a particular component arrangement is disclosed and illustrated in these exemplary embodiments, other arrangements could also benefit from the teachings of this disclosure.

The foregoing description shall be interpreted as illustrative and not in any limiting sense. A worker of ordinary skill in the art would understand that certain modifications could come within the scope of this disclosure. For these reasons, the following claims should be studied to determine the true scope and content of this disclosure.

What is claimed is:

1. A traction battery assembly, comprising:
an enclosure assembly having an interior area;
a pressure relief device having a valve member movable from a closed position to an unlocked-release position, and movable from the unlocked-release position to a locked-release position, the valve member in the closed position blocking flow through the pressure relief device from the interior area, the valve member in the unlocked-release position permitting flow from the interior area, the valve member in the locked-release position permitting flow from the interior area; and
a ratchet mechanism that holds the valve member in the locked-release position.

2. The traction battery assembly of claim 1, wherein the valve member is free to move back-and-forth between the closed position and the unlocked-release position.

3. The traction battery assembly of claim 1, wherein the valve member in the locked-release position permits more flow from the interior area than the valve member in the unlocked-release position.

4. The traction battery assembly of claim 1, further comprising a biasing device that biases the pressure relief device to the closed position.

5. The traction battery assembly of claim 4, wherein the biasing device is a coil spring.

6. The traction battery assembly of claim 1, wherein the ratchet mechanism includes at least one tooth.

7. The traction battery assembly of claim 1, wherein the ratchet mechanism is configured to block movement of the valve member from the locked-release position back to the unlocked-release position when the ratchet mechanism holds the valve member in the locked-release position.

8. The traction battery assembly of claim 1, wherein the ratchet mechanism is configured to hold the valve member in a first locked-release position that permits a first amount of flow from the interior area, wherein the ratchet mechanism is further configured to hold the valve member in a second locked-release position that permits a second amount of flow from the interior area, the second amount of flow greater than the first amount of flow.

9. The traction battery assembly of claim 8, wherein the valve member translates along an axis when moving from the closed position to the locked-release position, the ratchet mechanism having a first plurality of teeth circumferentially distributed about the axis that hold the valve member in the first locked-release position, the ratchet mechanism having a second plurality of teeth circumferentially distributed about the axis that hold the valve member in the second locked-release position.

10. The traction battery assembly of claim 9, further comprising a plurality of fingers of the pressure relief device, the plurality of fingers circumferentially distributed about the valve member, each of the fingers within the plurality of fingers including at least one of the teeth in the first plurality of teeth, and at least one of the teeth in the second plurality of teeth.

11. The traction battery assembly of claim 1, comprising a plurality of battery arrays housed inside the enclosure assembly.

12. The traction battery assembly of claim 1, wherein the valve member is configured to move from the closed position to the unlocked-release position in response to a pressure within the interior area exceeding a pressure outside the interior area by a first amount, wherein the valve member is configured to move from the unlocked-release position to the locked-release position in response to the pressure within the interior area exceeding the pressure outside the interior area by a second amount that is greater than the first amount.

13. A traction battery pack flow control method, comprising:
in response to a pressure within an interior area of an enclosure assembly exceeding a pressure outside the interior area by a first amount, transitioning a valve member of a pressure relief device from a closed position to an unlocked-release position; and
in response to the pressure within the interior area of the enclosure assembly exceeding the pressure outside the interior area by a second amount that is greater than the first amount, transitioning the valve member to a locked-release position.

14. The traction battery pack flow control method of claim 13, further comprising holding the valve member in the locked-release position using a ratchet mechanism.

15. The traction battery pack flow control method of claim 14, further comprising using at least one tooth to hold the valve member in the locked-release position.

16. The traction battery pack flow control method of claim 14, wherein holding the valve member in the locked-release position blocks movement of the valve member back to the unlocked-release position or the closed position.

17. The traction battery pack flow control method of claim 13, wherein the pressure relief device permits more flow from the interior area when the valve member is in the locked-release position than when the valve member is in the unlocked-release position.

18. The traction battery pack flow control method of claim 13, further comprising biasing the valve member toward the closed position.

19. The traction battery pack flow control method of claim 13, wherein the locked-release position is a first locked-release position, and further comprising, in response to the pressure within the interior area of the enclosure assembly exceeding the pressure outside the interior area by a third amount that is greater than the second amount, transitioning the valve member to a second locked-release position.

20. The traction battery pack flow control method of claim 19, wherein the pressure relief device permits more flow from the interior area when the valve member is in the second locked-release position than when the valve member is in the first locked-release position.
